(19) United States
(12) Patent Application Publication
(10) Pub. No.: US 2004/0203411 A1
(43) Pub. Date: Oct. 14, 2004

(54) Mobile communications device

(76) Inventors: Bernd Holz auf der Heide, Munchen (DE); Alexander Jarczyk, Freising (DE); Christoph Maggioni, Berlin (DE)

Correspondence Address: STAAS & HALSEY LLP, SUITE 700, 1201 NEW YORK AVENUE, N.W., WASHINGTON, DC, 20005, US

(21) Appl. No.: 10/297,674

(22) PCT Filed: May 23, 2001
(86) PCT No.: PCT/DE01/01979

(30) Foreign Application Priority Data
Jun. 7, 2000 (DE) 10028138.9

(51) Int. Cl. H04B 7/00

(52) U.S. Cl. 455/66.1; 455/575.1

(57) ABSTRACT

The invention relates to a mobile communications device comprising a transmitter and receiver unit that allows to establish a mobile communication. The device is further provided with an image sensor device that records the movements made with said device. The inventive device also comprises a processing unit that stores and processes the movements made with said device.

The invention relates to a mobile communications device in accordance with the precharacterizing part of the independent claim.

Such a device is known from WO 99/48268 and GB 2 329 300 A, for example. The latter document proposes a sensor unit for recording movements made with the device, said sensor unit having two optical sensors with different spectral sensitivities.

A pressure sensor is preferably a sensor which is in the form of a momentary-contact switch and whose contact is closed as soon as a prescribed pressure is exerted.

A publication (http:\\www.semiconductor.agilent.com\-cmos\tech.html, “CMOS Image Sensors”) in another technical field discloses an image sensor unit. Such an image sensor unit can be used to determine the (inherent) motion of a device on a surface by recording a succession of images and analyzing the changes from one image to the next.

Signature verification methods are known generally. These involve a user authenticating himself using his signature. The signature is compared with a sample signature, and authentication is successful if the sample signature and the signature provided do not differ by more than a prescribed margin.

Similarly, methods for recognizing characters entered in handwriting are known. Handwriting recognition is performed in numerous commercially available pocket computers for managing and organizing appointments and/or addresses.

A mobile communications device (mobile telephone or mobile) is known generally. For the purpose of authentication, the user enters an identification number (PIN=Personal Identification Number) on a keypad on the mobile telephone. A drawback in this case is that the user has to remember the identification number and that anyone gaining possession of the identification number is able to use the mobile telephone.

The object of the invention is to specify a mobile communications device which allows convenient operation.

This object is achieved in line with the features of the independent patent claim.

A mobile communications device is specified which has a transmission and reception unit for performing the mobile communication. In addition, an image sensor unit is provided which records movements made with the device. The device also has a processor unit for storing and further processing the movements made with the device.

In particular, the image sensor unit in this case is in the form of an optical motion sensor.

A particular advantage in this context is that the device is in a form similar to a pen and that the image sensor unit is used to record writing movements made with the device.

This means that, by way of example, a user is able to authenticate himself with the device by using at least part of the device to provide a signature, i.e. by moving this part like a pen. The signature is recorded using the image sensor unit and is compared with a reference signature using the processor unit. A known signature verification method is used to ensure that the signature provided using the device authenticates the authorized user. Handling the mobile communications device like a pen used to provide a signature corresponds to a natural operation which is well known to the user and which he will readily accept. In so doing, attributes individual to the user, i.e. characteristics of his signature, are used for authentication. In addition, the user does not need to remember an identification number (PIN).

Another refinement involves the device comprising a display (or a display unit) on which the recorded and recognized movement is displayed symbolically or in the form of its content for control purposes. Thus, as soon as a telephone number entered in handwriting using the device and recognized by virtue of the movement [lacuna] can be displayed to the user before it is actually dialed. If the mobile communications device is in the form of a pen in this case, a display having small dimensions in the pen can provide information about the characters recognized in the handwriting.

The handwriting recognition can be used to transmit commands prescribed in handwriting to the mobile communications device by virtue of the user making a handwritten entry which corresponds to a prescribed command which triggers a prescribed action on the device. Examples of such prescribed actions are setting the volume setting a tone level for the ringer tone or programming optional parameters (illumination, standby time, etc.)

Another development is that an activation sensor is provided which is set up such that the image sensor unit is switched on (activated) by operating the activation sensor.

In this case, the activation sensor can be a pressure sensor which, when operated, indicates that the image sensor unit can now expect a handwritten entry.

Alternatively, the activation sensor is in the form of a switch or momentary-contact switch. When the user presses the momentary-contact switch, he can make an entry; the image sensor unit is activated. The activation sensor can also be a pushbutton coupled to the image sensor unit. In this case, the pushbutton is turned on by pressing the device on a writing pad, which results in the image sensor unit being activated. It is thus possible for the strokes made on the surface to be deliberately distinguished from the strokes made above the surface.

As another alternative, the activation sensor can be a proximity switch. Hence, the image sensor unit is activated when the device approaches a prescribed minimum proximity to a surface. This allows “virtual writing”, i.e. it is not absolutely necessary for the device to be actually placed in contact with the surface when it is moving thereon.

An additional development involves the image sensor unit being able to be arranged in the device such that it can be protected. In this case, the image sensor unit in active mode is protected from physical influences by the shape of the device; to capture movements made with the device, the image sensor unit is extended from the device, for example.

Another development involves a writing unit being provided in the device which documents the movement of the device on the surface using colored writing. This is of importance for acceptance by the user, who can see all of his writing and thus knows what should be recognized by the device.

In this context, it will be noted that the writing unit can be designed to be able to be switched on, so that the device described can be used either for virtual writing or for actual writing, leaving behind the colored writing.

Another development is that a writing recognition means is provided which is set up such that it is possible to recognize writing which corresponds to the movement recorded by the image sensor unit.

Another refinement is that the recognizable character is a writing character, a symbol or at least part of a graphic. This allows recognition not only of writing characters but also of prescribed symbols and of graphics. The user can thus also use the device for drawing and hence for capturing his drawings. The movements made with the device over the surface and the associated writing, characters or drawings can be the subject of transmission using the device.

In this case, it will be noted that the drawing does not necessarily need to be recognized, but rather can be transmitted transparently—that is without recognition, e.g. in the form of a bitmap—to a receiver. By way of example, a handwritten fax—without separate recognition—can be transmitted in binary form to a receiver in this way on the basis of the writing on this fax. Alternatively, the writing on the fax can be examined for recognizable characters in order thus to allow, by way of example, memory-saving transmission of the content—and not of the writing characters which are in the form of graphics. With or without recognition of the characters, the device described can be used to select different transmission modes and formats: thus, besides fax, it is also possible to send email, SMS or the like. Alternatively, the content of a fax message can comprise graphics and recognized writing characters.

One development is that a feedback unit is provided which feeds back a state of the character recognition means or the state of the recognition. In this case, the feedback can be provided not only on the display indicated above but also haptically, e.g. by virtue of the device vibrating, or audibly. In particular, the degree or type of feedback can be dependent on the degree of recognition.

Thus, when the device is used, for example, the character recognition means can indicate that the written character has been recognized by virtue of brief vibration and/or a trill; the strength of the vibration or the volume of the trill indicates the degree of recognition.

In this context, it is also possible for feedback actually to be provided early—that is to say before writing has ended. One example is when the device moves in line with writing for a name which is linked to a number in a telephone book in the processor unit's memory. As soon as a part of the writing which, in respect of the part of the name which is still missing, means that only this one name is possible has been recognized, that is to say all except this one name can be excluded from the set of all the names in the telephone book on the basis of the progression of the writing, audible or haptic feedback is provided to indicate that entry can be ended. Thus, depending on the size of his telephone book, the user may already have unambiguously identified the addressee after just a few letters and can stop entering further letters. The feedback can also be provided by means of (synthetic) voice output over a loudspeaker; in the cited example, the name found is thus read aloud, and confirmation of dial-up may be requested.

Another refinement involves the device being of distributed design. Thus, by way of example, an input unit in pen form is arranged separately from a supplementary unit having a (large) display unit, in particular. The two separate units can communicate using a radio interface or a cable. This has the particular advantage that the functionality of the input unit, which can preferably be in the form of a pen, is small and simple, whereas additional functionalities are integrated in the supplementary unit. It is also possible for the input unit to be a pen having the extended functionality of input for the device.

An additional development provides a means for authenticating the user which is set up such that the writing is compared with a prescribed pattern and a degree of similarity is determined, with the user being authenticated if the degree of similarity is below a prescribed threshold value, and the user not being authenticated if the degree of similarity is not below the prescribed threshold value.

In general, it is possible to perform any type of data input by means of handwritten entry as well, with handwritten entry preferably being converted by means of handwriting recognition into a format which can be read by a computer, e.g. ASCII code. It is also possible to store the handwritten entry without the handwriting recognition, however (e.g. as a bitmap graphic, i.e. in the form of single pixels). It is thus sometimes not always necessary for the content of the handwritten entry to be recognized: if, by way of example, a fax is sent using the mobile communications device, then it is important to provide an option for data capture (digitization) of the handwritten entry including transmission to an addressee. This allows sketches or diagrams to be transmitted to the addressee without the contents thereof first needing to be subjected to complex recognition.

Another advantage of the device described is also that it can be operated using just one hand. On a surface, for example, one hand can be used to actuate the device, to select a receiver and to initiate a telephone call. If the device also comprises the normal components of a mobile telephone, such as loudspeaker and microphone, then the device or the input unit of the device (which is preferably in pen form) serves as a mobile telephone.

Developments of the invention can also be found in the dependent claims.

Exemplary embodiments of the invention are illustrated and explained below with reference to the drawings, in which

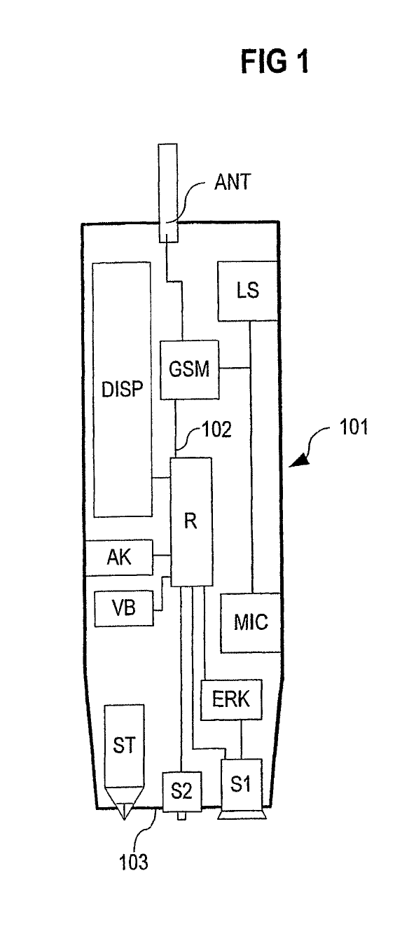

FIG. 1 shows a mobile communications device in pen form;

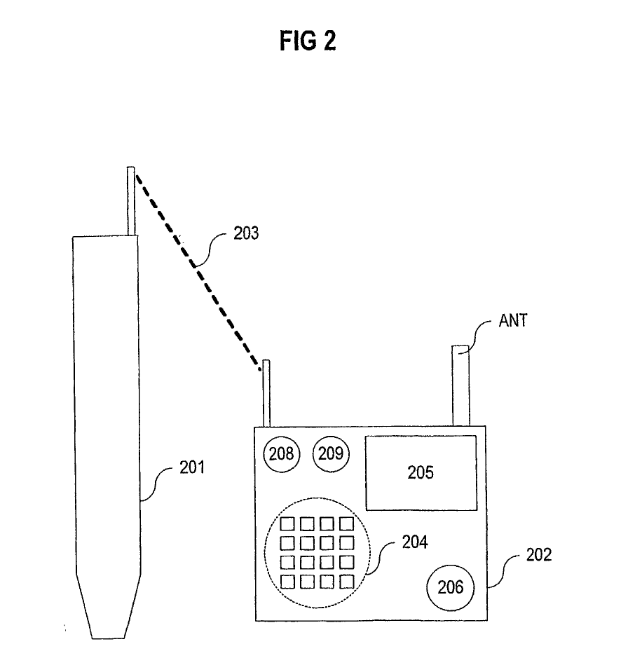

FIG. 2 shows a mobile communications device in the form of a mobile telephone with an input unit in pen form for recording movements.

FIG. 1 shows a mobile communications device 101 which is in pen form. The device 101 has an antenna ANT which is connected to a radio module GSM comprising a transmission unit and a reception unit. In addition, a first loudspeaker LS and a microphone MIC are provided which allow telephone communication using the radio module GSM. To this end, the user holds the first loudspeaker LS of the device to his ear and holds the microphone MIC close to his mouth, so that he can use the device like a conventional mobile telephone (mobile).

The radio module GSM can be in a form similar to a conventional mobile telephone. Only the input interface of the conventional mobile telephone is replaced by a connection 102 in FIG. 1. This makes allowance for the device's different form of input as compared with the mobile telephone, which is described below.

The connection 102 couples a processor unit R to the radio module GSM. Data or characters are entered using an image sensor unit S1, which is in the form of an optical motion sensor. This image sensor unit S1 is used to record or determine movements by the end 103 of the device on and/or close to a surface. Optionally, the movements are recognized using a character recognition means ERK on the basis of a stock of predetermined characters, and the recognized character(s) is/are then transmitted to the processor unit R, or else the profile of the movement itself (in the form of position data) is transmitted directly—without separate recognition—to the processor unit R.

To prevent primarily the movements on or in the direct vicinity of the surface from being recorded, an activation sensor S2 is provided which is in the form of a momentary-contact switch. When the end 103 of the device 101 touches the surface, the momentary-contact switch S2 is pressed and hence the image sensor unit S1 is activated. Conversely, when the momentary-contact switch S2 is not pressed, the image sensor unit S1 is also inactive. To this end, the activation sensor S2 is connected to the processor unit R. The processor unit R converts the signals into valid and invalid movements of the device 101 in line with the gestures described. In this case, the valid movements represent the writing.

Alternatively, the activation sensor S2 can also be in the form of a proximity switch. In this case, when there is less than a prescribed distance between the end 103 of the device 101 and the surface, the image sensor unit S1 is activated, so that valid movements can now be transmitted from the image sensor unit S1 to the processor unit R—directly or indirectly via the character recognition means.

It should be noted in this context that the selective recognition of writing characters, symbols or the like using the character recognition means allows different predefined characters to be determined merely by moving the device on a surface. On the other hand, it is also possible to store the profile of the movement transparently, e.g. as a graphic, and to send it to a receiver using the radio module GSM. In this case, different types of format and mode of data transmission can be used: it is thus possible to send part graphics, part recognized text in the form of ASCII characters to the receiver as a fax or email. Any desired combinations of modes and formats are conceivable in this context, depending on the respective area of application.

In addition, the device 101 in FIG. 1 also comprises a pen ST for visualizing the movement of the device 101 on the surface. The pen is preferably designed to be able to be switched on—comparable with the mechanism for extending the writing point in a ballpoint pen. This has the advantage that, depending on the type of surface, e.g. table, pants, paper, the user can put the pen ST into the writing state—or indeed not. In many cases, the visualization of the movement results in increased user acceptance, because he can see what he is writing.

In addition, the image sensor unit S1 can also—similarly to the mechanism of the pen ST described above—be designed to be extendable, so that the image sensor unit S1 itself is protected by the housing of the device 101 when it is in an inactive state.

To provide the user with feedback regarding his entry, a display unit (display) DISP, a second loudspeaker AK and a vibration unit VB are provided. The display can be used to visualize the user's entry—that is to say movement of the device over the surface—at least in part. This applies particularly when the character recognition means has been used to recognize particular characters, symbols or commands: in this case, a dialog can be conducted with the user by virtue of the display showing, by way of example, the recognized command and the request for confirmation, e.g. in the form

“Erase telephone number?”—“Please confirm with ‘YES’”

When the user sees this output on the display, he can simply use the device to write “YES” or a short command having the same meaning, e.g. a line from bottom left to top right.

The display is also suitable as a feedback unit for showing incomplete entries. An example in this regard is as follows: The user has stored an entry “Kammermeier” with an associated telephone number “1234567890” in his telephone book (in the memory of the radio module GSM). Apart from that, the telephone book contains only one other entry starting with the letter “K”: “Kammerl”. The user now wishes to use the device 101 described to call the addressee “Kammermeier” and, to this end, uses the device 101 to write the letters “K”, “A”, “M”, “M”, “E”, “R”, “M” on a surface (either with or without the assistance of the pen ST). Upper case and lower case are preferably insignificant in this context. The entry of single letters instead of words written in joined-up writing increases the recognition performance. Each individual letter is can shown on the display when it has been recognized. While there are a plurality of possible entries in the telephone book, no unambiguous association can be made. If the association is unambiguous, however (in the above example, when the last “M” has been entered), then—in line with the condition chosen in the example—the addressee can now only be “Kammermeier”. This is indicated to the user. He can now start dialing directly without needing to enter the rest of the letters.

In this context, it will be noted that, instead of entering the letters themselves, it is also possible to execute commands by moving the device. In this case, in particular, each command has a predefined writing stroke, that is to say a movement of the device. This allows the user to communicate directly with the device, for example to move “forward” and “backward” in the telephone book entries, with “forward” and “backward” then being such prescribed commands.

Accordingly, the feedback can also be provided by means of the second loudspeaker AK using audible feedback, for example a high tone for a correctly recognized character, and a low tone for a movement which could not be recognized. Alternatively or in addition, the user is provided with haptic feedback by virtue of the device 101 vibrating, caused by a vibration unit VB. In this case, the degree of vibration can provide information about the degree of recognition. Similarly, the volume of the tone which is output via the second loudspeaker AK provides information about the degree of recognition. In this case, degree of recognition relates to a measure which allows an indication to be given of how well the character recognition means has been able to recognize a character.

FIG. 2 shows a distributed mobile communications device having an input unit 201 in the form of a pen for recording movements and having a second unit 202. The second unit 202 comprises an antenna ANT and a large portion of the individual components shown in FIG. 1. The input unit 201 and the second unit 202 are connected to one another by means of a radio interface 203. The radio module GSM (see FIG. 1) is arranged in the second unit 202. This unit also contains batteries or storage batteries for supplying power to the radio module. The input unit 201 preferably has the components of pen ST, image sensor unit S1 and activation sensor S2. Optionally, a feedback unit for haptic feedback VB, a feedback unit for audible feedback AK, character recognition means ERK and a display DISP can be provided. To implement the telephony functionality, the input unit 201 also contains a first loudspeaker LS and a microphone MIK, in particular. To explain the functionalities of the individual components, reference is made to the comments regarding FIG. 1.

The advantage of this embodiment is that the user has space for a larger display 205 on the second unit 202 for the purpose of interaction. In addition, the second unit 202 has a keypad 204 which the user can use to make specific additional entries. The second unit is also provided with a camera 206 which can be used for video telephony. In addition, a loudspeaker 208 and a microphone 209 are provided which allow hands-free talking, particularly when telephoning. If the radio interface 203 has sufficient dimensions, the activated second unit 202 can remain in the briefcase, for example, while telephone calls are initiated, conducted and ended using the input unit.

1. A mobile communications device,
a) having a transmission unit and a reception unit for performing the mobile communication;
b) having a sensor unit for recording movements made with the device;
c) having a processor unit for storing and further processing the movements made with the device, characterized in that the sensor unit is an image sensor unit.

2. The device as claimed in claim 1,
in which the image sensor unit is an optical motion sensor.

3. The device as claimed in one of the preceding claims,
in which the device is in the form of a pen.

4. The device as claimed in one of the preceding claims,
in which a display is set up such that the display can show a control information item for the data read in using the image sensor unit.

5. The device as claimed in one of the preceding claims,
having an activation sensor which is set up such that the activation sensor activates the image sensor unit.

6. The device as claimed in claim 5,
in which the activation sensor is a switch or a momentary-contact switch.

7. The device as claimed in claim 5,
in which the activation sensor is a proximity switch.

8. The device as claimed in one of the preceding claims,
in which the image sensor unit is arranged in the device such that it can be protected.

9. The device as claimed in one of the preceding claims,
in which a write unit is additionally provided.

10. The device as claimed in one of the preceding claims,
in which a character recognition means is additionally provided which is set up such that it is possible to recognize a character corresponding to the movements recorded by the image sensor unit.

11. The device as claimed in claim 10,
in which the recognizable character is a writing character, a symbol or at least part of a graphic.

12. The device as claimed in one of claims 10 or 11,
in which a feedback unit is provided which feeds back a state of the character recognition means.

13. The device as claimed in claim 12,
in which the feedback unit provides haptic feedback.

14. The device as claimed in claim 12 or 13,
in which the feedback unit provides audible feedback.

15. The device as claimed in claim 13 or 14,
in which the feedback depends on the degree of recognition.

16. The device as claimed in one of the preceding claims,
in which the device is in the form of a distributed unit.

17. The device as claimed in one of the preceding claims,
in which the data which are read in comprise characters, symbols or graphics.

18. The device as claimed in one of the preceding claims,
in which a means for authenticating a user is provided which is set up such that the writing is compared with a prescribed pattern and a degree of similarity is determined, and
a) the user is authenticated if the degree of similarity is below a prescribed threshold value,
b) the user is not authenticated if the degree of similarity is not below the prescribed threshold value.
